(19) United States
(12) Patent Application Publication
(10) Pub. No.: US 2011/0041247 A1
(43) Pub. Date: Feb. 24, 2011

(54) ALLERGEN-BARRIER BEDDING COVER

(76) Inventor: Hyungsang Moon, Sungnam-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/859,476

(22) Filed: Aug. 19, 2010

(30) Foreign Application Priority Data
Aug. 21, 2009 (KR) 20 2009 0010948

(51) Int. Cl. A47G 9/00; D05B 3/12; B23P 17/00

(52) U.S. Cl. 5/490; 5/501; 5/499; 112/475.16; 29/527.1

(57) ABSTRACT

An allergen-barrier bedding cover made of polyurethane coated cover fabric, which is waterproof yet permeable to water vapor, reduces contamination of bedding, and blocks dust mites and other allergens, and can be washable. The outer face of cover fabric is non-allergic cotton, nano fiber, or Lyocell, and the inner face of cover fabric is coated with polyurethane. The closure is formed with a zipper, of which the back is coated with polyurethane in order to seal the needle holes of the seams sewing zipper tapes and teeth together, and the gap between teeth is less than 0.01 mm to prevent dust mites from passing through it, and the width of the zipper chain is less than 4 mm. A patch coated with polyurethane is attached inwardly at the end of the zipper, where the zipper is closed, to prevent dust mites from passing through the zipper slider. The needle holes of the seams not only between cover fabrics but also between cover fabrics and zipper tapes of the closure are sealed with seam sealing tapes. The allergen-barrier bedding cover prevents the cause of allergy and keeps the sleep environment clean and hygienic.

### TECHNICAL FIELD

This invention refers to a bedding cover that prevents dust mites and allergens in houses, that is, the allergen-barrier bedding cover formed with polyurethane coated cover fabrics, which is waterproof yet permeable to water vapor, and a zipper as a closure reduces damages from dust mites and other allergens.

### BACKGROUND

One of the main factors of causing allergy in a house is dust mites. A dust mite (Dermatophagoides Pteronyssimus) belongs to a spider family and its size is between 200 microns and 300 microns (0.2 mm to 0.3 mm). Its feces known as the direct cause of allergy cannot be distinguished with airborne dusts. The ideal condition for dust mites is a temperature of about 25° C. and a humidity of 80%. Dust mites inhabit mattresses, duvets, sofas, and pillows and they eat dead skin cells, horny tissues, and dandruff and take moisture from body fluids and sweat. It is commonly known that about 3,000 dust mites are found in a gram of house dust, and more than two million dust mites inhabit a three-year-old mattress. A dust mite itself does not cause allergy, but its feces with the size of 0.02 mm, known as Der pl, does. This feces is airborne and can cause allergy when inhaled. Main allergic reactions caused by dust mites feces include asthma (80% of child asthmatics react against feces of dust mites), rhinitis, itchy eyes, sneezing, and eczema.

Since the awareness spreads that dust mites cause allergies, various ideas to prevent them have been presented. A simple form of a pad coated with PVC to prevent contamination of bedding itself has been developed. This kind of pad has limited waterproof function, but it is exposed to dust mites and other allergens. There is a bedding cover made of non-woven, so-called Tyvek, but it is not washable. Another problem of Tyvek is that it provides the condition in which more dust mites inhabit the inside of bedding because they freely pass through needle holes of seams. Dust mites have no problem passing through the needle holes, considering that the size of a dust mite is 0.2 mm to 0.3 mm.

Korean Patent No. 10-2004-0072302 presented a production method of textiles having the effects of prevention of dust mites and antimicrobial, insecticidal effects by use of ocher dyes; but it is not to block dust mites perfectly, but to force dust mites to evade from the textiles. Bedding covers should be washed regularly and repeatedly and, in that case, the textiles with ocher dyes cannot keep the same evasion ratio against dust mites. Also, the textiles with ocher dyes have needle holes when sewn to make bedding. At first, dust mites run away through the needle holes, but when the antibiosis of the textiles declines due to repeated washing, they invade into the inside of bedding through the needle holes again. More inventions regarding bedding covers preventing dust mites are presented abroad. Korean Patent No. 10-0476578-0000 presented an anti-allergenic cover invented by a German company. This patent is also registered as U.S. Pat. No. 5,321,861, with the same contents. The cover is comprised of a fabric that is coated with polyurethane-acrylate copolymer foam and a zip fastener that is sealed on the inner face of the cover by overlapping with a sealing strip made from at least three plies of fabric. According to this invention, the cover fabric and the zip fastener are connected with seams having allergen-inhibiting impermeability. However, generally, sewing has needle holes and it is hard to block fine particles passing through them. Also, this invention focuses on the connection of the cover fabric and the zip fastener and, thus, fails to show how to connect cover fabrics together and how to prevent allergens from passing through the seams of them.

U.S. Pat. No. 5,050,256 presents an allergen-proof bedding system with polyurethane coated cover, which is permeable to water vapor, while being impenetrable to free water. This invention is worthy of praise in a sense that it uses the polyurethane coated fabric to prevent dust mites and other allergens from their food source. This kind of fabric is already used commercially known as Baxenden Witcoflex 971/973.

According to this invention, seams are “desirably” sealed by an additional polyurethane coating. However, it fails to show precisely how to seal with “an additional polyurethane coating.” Also, it explains neither how to seal the seams of polyurethane-coated fabrics and a zipper, nor how to block zipper teeth, which is a pathway for dust mites and other allergens.

U.S. Pat. No. 5,321,861 presents a protective cover made from a microporous ultrafilter material having a pore size of less than 0.0005 mm to suppress passage of fecal particles produced by house dust mites. The seams of the cover are sealed by gluing, heat sealing, or high-frequency welding, and its opening is sealed by a resealable fastener, such as a zip fastener, covered with an adhesive tape. It is desirable to seal the seams to block the pathway of dust mites. However, even though the material of the cover is microporous, it is permeable to water and, thus, bedding inside the cover can be contaminated with sweat or saliva. Also, it is cumbersome to take off adhesive tapes for washing and put them on again for use.

Finally, U.S. Pat. No. 6,017,601 presents an allergen-barrier cover that is comprised of a multi-layer fabric such as a polypropylene SMS fabric that allows passage of air, but blocks the passage of allergens and liquid water, and a plastic zipper seal such as a Ziplock. It is excellent to seal the closure of the cover with a Ziplock, but there is a problem with polypropylene fabric. It is contradictory to say “permeable to air, yet waterproof.” If air permeates, then water also does. A fabric not permeable to air should be used to secure that it is waterproof.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Embodiments of the present invention refer to a bedding cover made from a polyurethane coated fabric, which is permeable to water vapor, yet waterproof, and a polyurethane coated zipper, and the purpose of the invention is to reduce causes of allergy and keep a clean home environment by preventing dust mites and other allergens from bedding.

An ideal habitat of dust mites, one of the main causes of allergy, is a temperature of about 25° C. and a humidity of 80%, and they thrive on pillows, duvets, and mattresses at home. They eat dead skin cells, horny tissues, and dandruff, and take moisture from sweat, saliva, and other body fluids. Thus, it is prior to prevent those food sources from penetrating into the inside of bedding covers. In order to do that, it is necessary to use polyurethane coated fabric as a bedding cover. The outer face of the bedding cover, since it directly touches the human body, is non-allergic cotton, terry, synthetic fiber with cotton and polyester, nano fiber, or Lyocell, and the inner face of the bedding cover is polyurethane. The bedding cover with polyurethane coating is non-sticky to the human body, 100% waterproof, and permeable to water vapor. Also, it is washable 120 times with 95° C. hot water and, thus, easily sterilized against feces of dust mites.

Considering that the size of a dust mite is 0.2 mm or 0.3 mm, it passes freely through needle holes of the seams of a bedding cover. Thus, it is necessary to seal the needle holes. Embodiments of the present invention are characterized with that the needle holes are sealed with polyurethane film known as seam sealing tape, of which the thickness is 0.02 mm-0.03 mm.

The polyurethane film is highly elastic and durable against repeated washing because its tensile strength is 100˜200 kgf/cm², and its elongation is 250-350%. The method of sealing the needle holes with said seam sealing tape is as follows: a seam sealing machine is used to seal the needle holes of the seams with the seam sealing tape in a way that the seam sealing machine applies compressed hot air onto the one side of the seam sealing tape and, right after the seam sealing tape gets adhesive, the seam sealing machine presses it down onto the needle holes along the seams. The seams of cover fabrics and a zipper are sealed as same as the above.

Another pathway of dust mites is a closure of the bedding cover to put in and take out bedding, wherein the closure is formed with a zipper. In case of a spiral zipper, zipper teeth and a zipper tape are sewn together and dust mites are able to pass through either the seams between the teeth and the zipper tape or between teeth themselves. In order to block all the possible pathways of dust mites at the closure, the following steps are necessary: the inner face of the zipper tape of the zipper is coated with polyurethane; the gaps of zipper teeth themselves are less than 0.01 mm; the material of zipper teeth is plastic or rubber; and the width of the zipper chain is less than 4 mm; also, a patch coated with polyurethane is attached at the one end of the inner face of a bedding cover in order that dust mites cannot pass through the zipper slider when the bedding cover is closed; and finally, the seams of the patch are sealed with said polyurethane film.

The effects of the invention are to reduce contamination of pillows, duvets, and mattresses with a completely sealed bedding cover made from a polyurethane coated fabric, which is permeable to water vapor and washable, and a polyurethane coated zipper, and ultimately to reduce causes of allergy and keep a clean home environment by preventing dust mites and other allergens from bedding.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is an inside-out perspective view of a pillow cover according to one embodiment of the present invention;

FIG. 2 is a perspective view of a mattress cover according to one embodiment of the present invention;

FIG. 3 is a diagrammatic cross section of A in FIGS. 1 and 2;

FIG. 4 is an alternative diagrammatic cross section of A in FIGS. 1 and 2;

FIG. 5 is an alternative diagrammatic cross section of A in FIGS. 1 and 2;

FIG. 6 is an alternative diagrammatic cross section of A in FIGS. 1 and 2; and

FIG. 7 is a perspective view of closure (30) in FIGS. 1 and 2.

### DETAILED DESCRIPTION

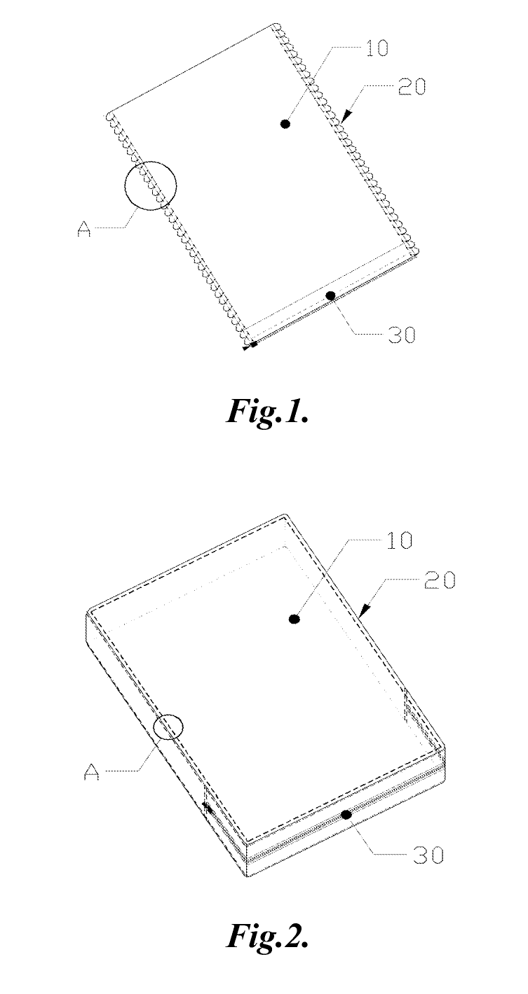

As shown in FIG. 1 and FIG. 2, the bedding cover is comprised of polyurethane coated cover fabric (10) that covers up bedding, and a closure (30) that is formed along a side or three sides of said bedding cover. Said polyurethane coated cover fabric (10) is cut in certain sizes, turned inside out, and sewn. As shown again in FIG. 1, said closure (30) and said polyurethane coated cover fabric (10) are sewn together, and then the upper and bottom parts of said polyurethane coated cover fabric are sewn together. Said closure (30) is formed with a zipper on a side of the bedding cover for pillow and cushion covers, and three sides of the bedding cover for mattress and duvet covers. Also, in case of mattress covers, the bedding cover is formed in a shape of a rectangular parallelopipedon, and each surface is made from said polyurethane coated fabric (10).

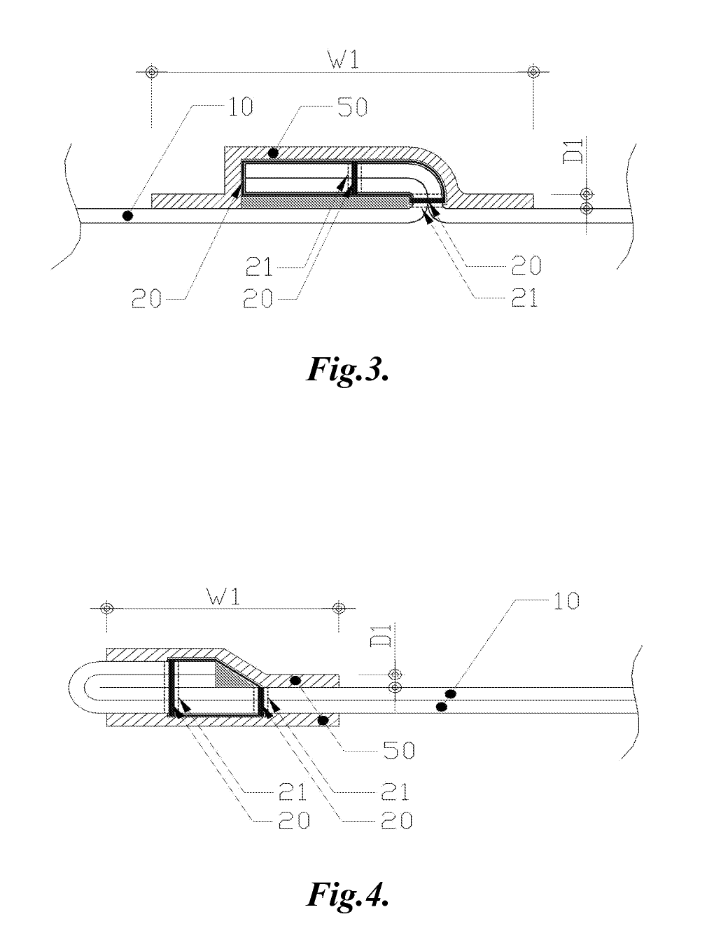

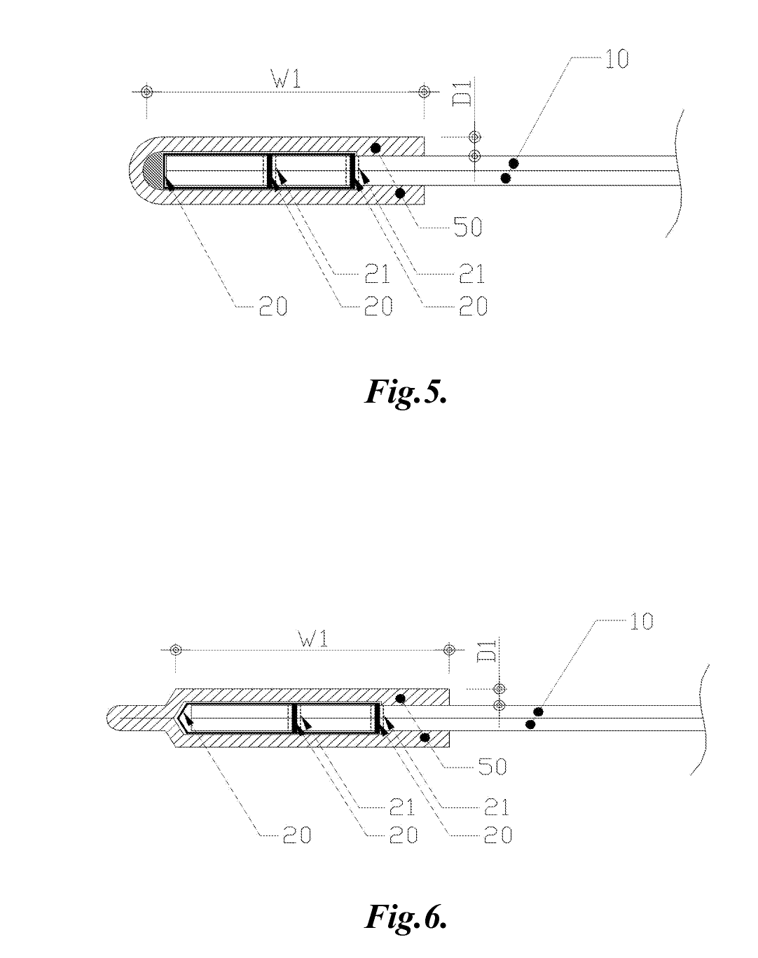

FIG. 3, FIG. 4, FIG. 5, and FIG. 6 show the different ways of sewing said polyurethane coated cover fabrics (10) together and sealing the needle holes with polyurethane film (50).

Said polyurethane coated cover fabric (10) has the characteristics of being permeable to water vapor and yet being waterproof. Those fabrics have been commonly used, and earlier products are known as Baxenden Witcoflex 971/973 and Coverplus. The outer face of said polyurethane coated cover fabric (10), since it touches the human body directly, is non-allergic cotton, terry, synthetic fiber of cotton and polyester, nano fiber, or Lyocell, and the inner face is coated with polyurethane. Said polyurethane coated cover fabric (10) lets the water vapor generated from a human body emit through the cover fabric and prevents dust mites and other allergens from their food sources by blocking water and dead skin cells getting into the inside of bedding. Thus, it helps hygienic and comfortable sleep. Said polyurethane coated cover fabric (10) is permeable to water vapor in the range of 0.80-1.07 mg/cm²/h, and washable at 60° C. through 95° C. to the extent of 120 times.

FIG. 3, FIG. 4, FIG. 5, and FIG. 6 are four different examples of sewing and sealing. After said polyurethane coated cover fabrics (10) are sewn together, then the needle holes (21) are sealed with said polyurethane film (50).

A seam sealing tape forming said polyurethane film (50) has its tensile strength of 100˜200 kgf/cm² and its elongation of 250-350%, so that it is highly elastic and durable against repeated washing. Also, said seam sealing tape has the same characteristics as said polyurethane coated cover fabric (10) and its thickness is 0.02 mm-0.03 mm and its width is large enough to seal said needle holes (21).

How to seal said needle holes (21) of the seams with said seam sealing tape is as follows: a seam sealing machine is used to seal the needle holes of the seams with the seam sealing tape in a way that the seam sealing machine applies compressed hot air onto the one side of the seam sealing tape, and right after the seam sealing tape gets adhesive, the seam sealing machine presses it down onto the needle holes along the seams.

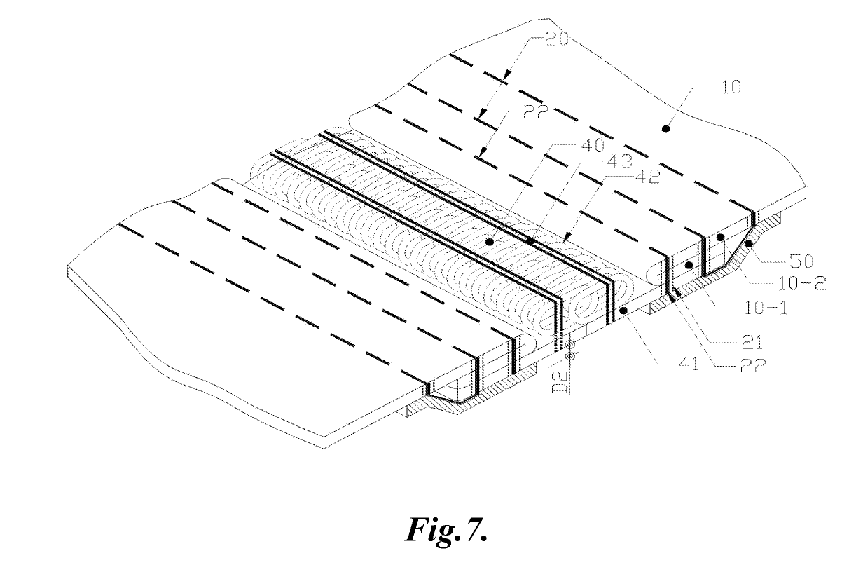

FIG. 7 shows a way to sew a zipper (40) and a polyurethane coated cover fabric (10) and to seal needle holes of the seams with a polyurethane film.

Said zipper (40) is a spiral zipper and, in order to prevent dust mites from passing through any parts of the zipper, the inner face of the zipper tape (41) of said zipper is coated with polyurethane, wherein said zipper tape (41) and zipper teeth (42) are sewn together, and the gap of said zipper teeth (42) is less than 0.01 mm. Also, the material of zipper teeth is plastic or rubber, and the width of the zipper chain is less than 4 mm. The material of said zipper tape (41) is durable polyester. The similar zippers are developed by YKK and OPTI, and now commonly used.

Said polyurethane coated zipper is sewn together with said polyurethane coated cover fabric (10), wherein said polyurethane coated cover fabric (10) is folded both sides as shown in FIG. 7, so that an upper part (10-2) and a lower part (10-1) of the polyurethane coated cover fabric are formed, and it is sewn together with said zipper tape (41). In case that the outer face of said polyurethane coated cover fabric is made from terry, said zipper tape (41) is sewn together only with the lower part (10-1) of the polyurethane coated cover fabric. The distance between the right and left side of the seams (22), in which said the upper part (10-2), the lower part (10-1) of the polyurethane coated cover fabric, and said zipper (41) are sewn together, should be enough so that the slider of said zipper (40) moves freely.

After three folded fabric, that is, said upper part (10-2), said lower part (10-1) of the polyurethane coated cover fabric, and said zipper tape (41), are sewn together, the inner face of it is sealed with the polyurethane film (50) and, thus, the needle holes (21) of all the seams are sealed completely. The width of said polyurethane film (50) is wide enough to cover up all the needle holes of the seams, and the thickness of it is 0.02 mm-0.03 mm. The methods to seal said needle holes (21) of the polyurethane coated cover fabric and said zipper (40) are the same as sealing the polyurethane coated cover fabrics.

A patch coated with polyurethane is attached at the one end of the inner face of a closure (30) in order that dust mites cannot pass through the zipper slider when the bedding cover is closed. The needle holes of the seams on the patch are sealed with said polyurethane film (50). The dimension of the patch coated with polyurethane is large enough to cover up said zipper (40), the seams of the cover fabric (10), and the zipper tape (41), and it is no bigger than 6 cm×8 cm.

While illustrative embodiments have been illustrated and described, it will be appreciated that various changes can be made therein without departing from the spirit and scope of the disclosure.

1. An allergen-barrier bedding cover comprising:
(a) a cover fabric coated with polyurethane, wherein the thickness of polyurethane is 0.02 mm-0.03 mm, and said cover fabric being permeable to water vapor in the range of 0.80-1.07 mg/cm2/h and being washable at 60° C. through 95° to the extent of 120 times, and thus said cover fabric being waterproof and permeable to water vapor;
(b) a closure formed with a zipper in order to put in and take out bedding, wherein the inside of the zipper tape of said zipper is coated with polyurethane, and the gap of zipper teeth is less than 0.01 mm, and the material of zipper teeth is plastic or rubber, and the width of the zipper chain is less than 4 mm;
(c) a patch coated with polyurethane, said patch being attached at the one end of the inner face of a bedding cover in order that dust mites can not pass through the zipper slider when the bedding cover being closed;
(d) a polyurethane film, said polyurethane film being used to seal the needle holes formed when cover fabrics are sewn and also when cover fabrics and zipper tapes are sewn.

2. The allergen-barrier bedding cover of claim 1, wherein the outer face of cover fabric coated with polyurethane is non-allergic cotton, terry, synthetic fiber with cotton and polyester, nano fiber, or Lyocell.

3. The allergen-barrier bedding cover of claim 1, wherein the polyurethane film is highly elastic and durable against repeated washing and said polyurethane film includes a seam sealing tape of which the tensile strength is 100-200 kgf/cm², and the elongation is 250-350%, and the thickness is 0.02 mm-0.03 mm.

4. The allergen-barrier bedding cover of claim 3, wherein a seam sealing machine is used to seal the needle holes of the seams with the seam sealing tape in a way that the seam sealing machine applies compressed hot air onto the one side of the seam sealing tape, and right after the seam sealing tape gets adhesive, the seam sealing machine presses it down onto the needle holes along the seams.

5. The allergen-barrier bedding cover of claim 1, wherein overlock or running stitch with two rows is used for sewing cover fabrics coated with polyurethane together in order that the seams are not broken easily against repeated washing, and running stitch, and overlock if necessary, is used for sewing zipper tapes and cover fabrics together.

6. The allergen-barrier bedding cover of claim 1, wherein the zipper is spiral and the zipper teeth are plastic or rubber, and the gap between teeth is less than 0.01 mm.

7. The allergen-barrier bedding cover of claim 1, wherein the dimension of the patch coated with polyurethane is large enough to cover up the zipper and the seam of cover fabric and zipper tape, that is, 6 cm×8 cm.

8. The allergen-barrier bedding cover of claim 1, made in the shape of a pillow cover.

9. The allergen-barrier bedding cover of claim 1, made in the shape of a mattress cover.

10. The allergen-barrier bedding cover of claim 1, made in the shape of a duvet cover.

11. The allergen-barrier bedding cover of claim 1, made in the shape of a cushion cover.

12. An allergen-barrier bedding cover comprising:
(a) a cover made from woven fabric coated with polyurethane, wherein the cover includes an opening;
(b) a closure disposed on the cover for closing the opening, the closure comprising a zipper having first and second ends, wherein the zipper is configurable between open and closed orientations, the zipper including first and second zipper tapes, first and second sets of zipper teeth, and a zipper slider configured to couple and decouple the first and second sets of zipper teeth between the first and second ends, wherein the first and second zipper tapes are coated with polyurethane, and wherein gaps between adjacent coupled zipper teeth are smaller than 0.01 mm; and
(c) one or more polyurethane films for sealing needle holes formed in the cover and the closure.

13. The cover of claim 12, further comprising a patch coated with polyurethane configured for covering the zipper slider at either of the first and second zipper ends.

14. The cover of claim 12, wherein the zipper is a spiral zipper.

15. The cover of claim 12, wherein the width of the zipper is less than 4 mm.

16. The cover of claim 12, wherein the thickness of the polyurethane coating for the woven fabric is in the range of 0.02 mm to 0.03 mm.

17. The cover of claim 12, wherein the woven fabric coated with polyurethane is permeable to water vapor in the range of 0.80 mg/cm²/h to 1.07 mg/cm²/h.

18. The cover of claim 12, wherein the one or more polyurethane films has tensile strength in the range of 100 kgf/cm² to 200 kgf/cm² and elongation in the range of 250% to 350%.

19. A method of making an allergen-barrier bedding cover comprising:
(a) obtaining a cover made from woven fabric coated with polyurethane, wherein the cover includes an opening;
(b) forming a closure on the cover for closing the opening, the closure comprising a zipper having first and second ends, wherein the zipper is configurable between open and closed orientations, the zipper including first and second zipper tapes, first and second sets of zipper teeth, and a zipper slider configured to couple and decouple the first and second sets of zipper teeth between the first and second ends, wherein the first and second zipper tapes are coated with polyurethane, and wherein gaps between adjacent coupled zipper teeth are smaller than 0.01 mm; and
(c) sealing needle holes formed in the cover and the closure.

20. The method of claim 19, wherein the needle holes formed in the cover and the closure are sealing using a seam sealing tape and an application of compressed hot air on the seam sealing tape.
